(19) United States
(12) Patent Application Publication
(10) Pub. No.: US 2024/0199809 A1
(43) Pub. Date: Jun. 20, 2024

(54) NON-ISOCYANATE POLYURETHANE FOAM COMPOSITION AND METHOD OF MAKING THE SAME

(71) Applicant: Algix, LLC, Meridian, MS (US)

(72) Inventors: Mark Ashton Zeller, Meridan, MS (US); Patrick Lewis Carter, Meridian, MS (US)

(73) Assignee: Algix, LLC, Meridian, MS (US)

(21) Appl. No.: 18/595,020

(22) Filed: Mar. 4, 2024

Related U.S. Application Data
(63) Continuation-in-part of application No. 17/072,310, filed on Oct. 16, 2020, now Pat. No. 11,920,033.
(60) Provisional application No. 62/911,255, filed on Oct. 5, 2019.

(51) Int. Cl. C08G 71/04; C08J 9/08

(52) U.S. Cl. CPC C08G 71/04; C08J 9/08; C08G 2110/005; C08G 2110/0058; C08G 2110/0066; C08J 2203/02; C08J 2375/12

(57) ABSTRACT

A thermoset non-isocyanate polyurethane foam (NIPU) composition includes a reaction product of a polycyclic carbonate, a polyamine; and a foaming ingredient including a carbonate-based chemical blowing agent. The reaction product is configured to form a urethane bond. The polycyclic carbonate and the polyamine can be bio-derived. A process for making the NIPU foam includes the steps of: (a) selecting a polycyclic carbonate and a polyamine; (b) mixing the polycyclic carbonate and the polyamine to form a reactant product including a partially cured gel matrix; (c) adding a foaming ingredient comprising a chemical blowing agent including a carbonate; (d) curing the mixture to form the NIPU foam. The reaction is tunable by changing cure temperature, water content, and/or acid composition.

### CROSS REFERENCE TO RELATED APPLICATION

This Application is a continuation-in-part of U.S. patent application Ser. No. 17/072,310 filed Oct. 16, 2020, which claims priority to and the benefit of U.S. Provisional Patent Application No. 62/911,255 titled “NON-ISOCYANATE POLYURETHANE FOAM COMPOSITION” and filed on Oct. 5, 2019, and the disclosure of these applications are incorporated herein by reference in their entirety for all purposes.

### TECHNICAL FIELD

The present disclosure relates generally to the field of polymer foams and end products, particularly polyurethane foams.

### DESCRIPTION OF RELATED ART

Interest in producing sustainable material solutions and improving the safety of chemical products has created major changes in many industries. However, polyurethane (PU) chemistry has remained largely unchanged. The use of isocyanates has resulted in severe health hazards with both acute and chronic health implications and are made using phosgene, a highly dangerous and regulated gas. Despite the risk, they remain the predominant chemical used in PU compositions. This is because while isocyanate is very hazardous, it is also very reactive and is capable of quickly forming urethane linkages as well as producing gas when used with water. Isocyanate gas formation reactions and crosslinking reactions both proceed quickly and at a similar rate which allows for easy foam production since the speed of gas expansion is matched to the rate of polymer curing. Since the production of flexible and rigid foams dominates the PU market with a majority of PU profits being targeted at foam compositions, any technology which seeks to replace PU chemistry needs to be able to demonstrate the ability to foam in order to achieve broad market acceptance.

Work on non-isocyanate polyurethane (NIPU) chemistry has focused largely on using reactions between cyclic carbonates and amines to produce hydroxyl-polyurethane compositions with similar properties to conventional PU. However, this technology was previously limited to work in foaming because amines lack reactivity with water which produces a suitable blowing gas and the reaction rates of NIPU reactions was too slow to cure on a time scale which is foamable. The majority of NIPU compositions, thus far, have been targeted at the generation of coatings and other applications where slower reactions are suitable and the hydroxy-polyurethane bonding structure may be useful. While it has been demonstrated that foam using amines with poly(methylhydrogensiloxane) MH-15 to remove hydrogen gas as a blowing agent is possible, the result lacks feasibility on a commercial scale for economic, safety, and material property reasons. The reactions generate hydrogen gas which poses a combustion risk. The MH-15 carries a high-cost relative to conventional PU chemistry components. The reaction yields a MH-15 molecule which is heavily cross-linked to amine sites, which is likely to produce unfavorable properties or at least limit the range of characteristic foam properties achievable.

Despite other attempts to solve the problems associated with forming improved PU foams, none teach or suggest a material and/or method having the benefits and features of the present disclosure.

### SUMMARY

The present disclosure provides for a non-isocyanate polyurethane (NIPU) foam. In an example, a thermoset NIPU foam composition is provided that includes a reaction product of: (a) a polycyclic carbonate, having a plurality of cyclic carbonate functional groups, ranging from 5 to 90% of the NIPU foam composition ingredients by weight; (b) a polyamine, having a plurality of amine functional groups, ranging from 5% to 90% of the NIPU foam composition ingredients by weight; and (c) a foaming ingredient configured to produce the NIPU foam composition ranging from 0.5 to 20% of the NIPU composition ingredients by weight. The foaming ingredient includes a carbonate-based chemical blowing agent. The polycyclic carbonate and the polyamine form a urethane bond. The cyclic carbonate functional group and amine functional group can be provided in a ratio in a range from 4:1 to 1:4. In another example, the cyclic carbonate functional group and amine functional group are provided in a ratio in a range from 2:1 to 1:2.

The polycyclic carbonate can be bio-derived and includes a carbonated triacylglycerol (TAG) or a fatty acid methyl ester (FAME) derived from one or more natural oils. In a further example, the polycyclic carbonate includes 15 to 80% of the NIPU foam composition by weight. The polyamine can also be bio-derived compound selected from the group consisting of hexamethylene diamine (HMDA), putrescine, cadaverine, chitosan/chitin, pentamethylene diamine (PMDA), decarboxylated lysine and polylysine. In yet another example, the polyamine includes 15 to 80% of the NIPU foam composition by weight. The resulting NIPU foam material can define a density from 1 to 400 kg/m³ and/or a Shore A hardness from 1 to 80.

The present disclosure further provides for a NIPU foam composition that includes a reaction product of the polycyclic carbonate, polyamine, and foaming ingredient having carbonate along with a catalyst selected from the group consisting of Lewis acids and bases, phosphoric acids, carbines, phosphines, enzymes, guanidines, thioureas, triazabicyclodecene (TBD), phenylcyclohexylthiourea, and combinations thereof. The catalyst can be introduced into the reaction prior to the chemical blowing agent. The carbonate-based chemical blowing agent can be provided in a loading by weight from 0.5% to 20%. The carbonate-based chemical blowing agent includes a carbonate selected from the group consisting of calcium carbonate, ammonium bicarbonate, sodium bicarbonate, potassium bicarbonate, sodium carbonate, calcite, aragonite, dolomite, kutnohorite, ankerite, magnesium carbonate, barium carbonate, potassium carbonate, zinc carbonate, copper carbonate, silver carbonate, carbonates or bicarbonates of group 1 metals, carbonates or bicarbonates of group 2 metals, carbonates of transition metals, and combinations thereof. In an example, the carbonate based chemical blowing agent is selected to produce a byproduct salt configured to confer a desired protective benefit to the NIPU foam composition with the byproduct salt is a salt of a metal selected from the group of metals consisting of copper, zinc, barium, and silver.

The present disclosure still further provides for a NIPU foam composition that includes a reaction product of the polycyclic carbonate, polyamine, and foaming ingredient having carbonate along with an accelerant introduced with the chemical blowing agent, wherein the accelerant includes water and an acid. The accelerant can be provided at a loading range by weight up to 15%.

The present disclosure still further provides for a NIPU foam composition that includes a reaction product of the polycyclic carbonate, polyamine, and foaming ingredient having carbonate along with a surfactant introduced with the chemical blowing agent. The surfactant can include a member selected from the group consisting of a silicone-based surfactant, a stearate, polyethylene glycol, polyethylene oxide, a polyorganic acid, sodium dodecyl sulfate, ethylene oxide, polypropylene oxide, an alkoxylate, propylene glycol, and combinations thereof. The surfactant can be provided at a loading range by weight from 0 to 15%.

The present disclosure still yet provides for a thermoset NIPU foam composition comprising a reaction product of: (a) a bio-derived polycyclic carbonate having a plurality of cyclic carbonate functional groups, a bio-derived polyamine having a plurality of amine functional groups, and a foaming ingredient configured to produce the NIPU foam composition, wherein the foaming ingredient comprises a carbonate-based chemical foaming blowing agent, and wherein the polycyclic carbonate and the polyamine form a urethane bond; (b) a catalyst reacted with the polycyclic carbonate and the polyamine prior to combining with the foaming ingredient; and (c) an accelerant and a surfactant provided as additional foaming ingredients configured to generate the NIPU foam having desired properties. The cyclic carbonate functional group and amine functional group are provided in a ratio in a range from 4:1 to 1:4. The desired properties of the NIPU foam include a density of the NIPU foam from 1 to 400 kg/m3 and a Shore A hardness from 1 to 80.

The present disclosure even further provides for a process for making non-isocyanate polyurethane (NIPU) foam composition including the steps of: (a) selecting a polycyclic carbonate and a polyamine; (b) mixing the polycyclic carbonate and the polyamine to form a reactant product comprising a partially cured gel matrix having urethane bonds; (c) adding a foaming ingredient including a chemical blowing agent including a carbonate; (d) curing the mixture of the reactant product including the partially cured gel matrix and the foaming ingredient to form the NIPU foam; (e) optionally adding a catalyst to step (b); and (f) optionally adding additional foaming ingredients selected from the group consisting of an accelerant, a surfactant, and a combination thereof prior to step (d). The polycyclic carbonate and the polyamine can each be bio-derived and the polycyclic carbonate and polyamine can be provided in a ratio in a range from 4:1 to 1:4.

### BRIEF DESCRIPTION OF THE DRAWINGS

The figures which accompany the written portion of this specification illustrate embodiments and method(s) of use for the present disclosure constructed and operative according to the teachings of the present disclosure.

FIG. 1 is a process flow chart of an example polyurethane foam production process according to the present disclosure.

FIG. 2 is a photograph showing a side-by-side cut through of a foamed and an unfoamed NIPU blend.

FIG. 3 is a photograph of side-by-side foamed and unfoamed NIPU, uncut, that was produced without catalyst or surfactant and used sodium bicarbonate as a chemical blowing agent along with the same cyclic carbonate and amine used in the examples of FIG. 2.

FIG. 4 is a first microscope photo taken at 10× zoom of the NIPU foam of FIG. 2.

FIG. 5 is a second microscope photo taken at 10× zoom of the NIPU foam of FIG. 2.

FIG. 6 a microscope phots taken at 10× zoom of a NIPU foam with no surfactant and with triazobicyclodecene as a catalyst.

The various embodiments of the present disclosure will hereinafter be described in conjunction with the appended drawings, wherein like designations denote like elements.

### DETAILED DESCRIPTION

The present disclosure provides for a non-isocyanate polyurethane (NIPU) foam composition of matter and methods to produce NIPU foam materials. The NIPU foam composition can be formed using a reaction product of a polycyclic carbonate and a polyamine forming a urethane bond combined with a chemical blowing agent. The cyclic carbonate and the amine can be bio-based or bio-derived.

In an example, the present disclosure provides for NIPU foam compositions and a process of making NIPU foam compositions, which has been demonstrated to be suitable for both flexible and rigid foam applications. In an example of the present disclosure, NIPU chemistry forming hydroxy-polyurethanes involves a reaction product of an amine component, such as a polyamine, and a cyclic carbonate component, such as a polycyclic carbonate, which react to form a hydroxy urethane linkage or bond. When combined with a foaming ingredient a foam is formed. Selecting an appropriate foaming ingredient (also interchangeably referred to as a foaming agent), that includes a blowing agent having a carbonate or bicarbonate, generates the NIPU foam. The cyclic carbonate and the amine component can be bio-derived. A foaming ingredient can be any material that contributes to forming a foam. A blowing agent can be defined as a material that produces gas when combined in a reaction.

The cyclic carbonate or blend of cyclic carbonates may be bio-derived. This includes cyclic carbonated triacylglycerol (TAG) or fatty acid methyl esters (FAME) derived from natural oils such as soy, linseed, algae, flax, teak, fish and other oils. In an example, on average the FAMEs are polyunsaturated. Bio-derived cyclic carbonates may also be drawn from bio-derived polyol or polyol precursors used in conventional PU foaming. These polyols or polyol precursors may have been transesterified with FAME, which has at least one degree of unsaturation on average and can therefore be converted to a cyclic carbonate, or may have been epoxidized and carbonated at their sites of unsaturation. The polycyclic carbonate includes a plurality of cyclic carbonate functional groups. This can aid in the production of materials with similar properties to conventional PU foams since a significant portion of the final foam structure may mirror or resemble conventional PU. Petrochemical cyclic carbonates are also envisioned and suitable for foam production according to the techniques, process steps, and features of the present disclosure.

The selection of a cyclic carbonate can depend on cost, material property targets of the finished NIPU foam, viscosity, and the speed of the reaction rate. Cyclic carbonates can have faster reaction rates if they are not sterically hindered for amine attack which to some extent depends on the selected amine. Further, it has been observed that when aliphatic cyclic carbonates are found to share a neighboring carbon, a “zipper effect” occurs in which the reaction to fully cure occurs more quickly. Often the viscosity of the cyclic carbonate will be higher than the other components and as such lowering the viscosity of the cyclic carbonate as much as possible when selecting your cyclic carbonate will improve foam quality. Using higher viscosity cyclic carbonates may complicate mixing, making cells more likely to coalesce, and increasing the force needed to generate, with the blowing gas, a desired density of foam. In an exemplary embodiment, the viscosity for a polycyclic carbonate or polyamine would be in a range of 300 to 25,000 mPa·s including 500 to 20,000 mPa·s as well as 1000 to 18,000 mPa·s and 1500 to 15,000 mPa·s and 3000 to 12,000 mPa·s. Polycyclic carbonates, which have a plurality of cyclic carbonate functional groups, can be effective since in order to form a crosslinked network the number of crosslinking sites per molecule on average must be 2 or greater with the higher the degree of crosslinking the more rigid the foam is expected to be.

The present disclosure provides for a NIPU foam composition having a cyclic carbonate that makes up 5 to 90% of the composition by weight including 10 to 85% and 15 to 80% or various combinations within these ranges. Cyclic carbonate may be formed by any means and used with the present disclosure; however, they are often produced from a molecule with at least one degree of unsaturation. The carbon-carbon double bond in these molecules is epoxidized and then CO₂ is saturated into solution alongside an epoxidized molecule to replace the epoxide ring with a cyclic carbonate ring structure. Sometimes a catalyst such as tetrabutylammonium bromide (TBAB) may be used to stabilize the epoxide ring opening and allow the saturated CO₂ to attack and form the cyclic carbonate. Through the use of this process any starting molecule with at least one degree of unsaturation is suitable as a cyclic carbonate source such as the FAMEs described previously.

Amine selection also should consider cost, the material properties of the resulting NIPU foam, and reaction rate with steric hindrance again being a criterion to reduce reaction times to a feasible time scale to produce a desired foam. The amines should be polyaminated (e.g., a polyamine having a plurality of amine functional groups) to form a crosslinked network and preferably will have higher boiling and flash points to reduce the rate of material loss when foaming due to elevated temperatures. Amine selection should consider risk factors associated with user contact since, while they do not generally have the hazards from exposure that isocyanates do, they still carry some exposure risks namely tissue corrosion.

Amines may be bio-derived with commercially available sources existing including hexamethylene diamine (HMDA) and pentamethylene diamine (PMDA). HDMA is used in Nylon 6,6 manufacturing and PMDA is also used in Nylon which contains a five (5) carbon monomer segment such as Nylons (5,6), (5,11) and (5,12). Bio-derived amines can be produced from the decarboxylation of amino acids such as lysine or the formation of polylysines, through the amination of diols in the presence of ammonia, and preparations of chitosan/chitin or glucosamine, as well as through other means. There are also naturally occurring diamines such as putrescine (butanediamine) and cadaverine (pentamethylene diamine).

Polyamines are effective since the number of crosslinking sites per molecule on average must be two (2) or greater with higher crosslinking density yielding more rigid foam properties. According to the present disclosure, amines may make up 5 to 90% of the NIPU foam composition by weight including 10 to 85% and 15 to 80% or various combinations within these ranges.

In addition to cyclic carbonates and amines, an optional catalyst may be used in order to speed up the formation of a gelled polymer matrix and/or a fully cured polymer. Examples of known NIPU catalysts include but are not limited to: Lewis acids and bases, phosphoric acids, carbines, phosphines, enzymes, guanidines, and thioureas. An effective catalyst in terms of increasing reaction rate is generally found to be triazabicyclodecene (TBD) or phenylcyclohexylthiourea. These catalysts may be added during the initial mixing phase of foam production, wherein a gel matrix is being formed or they may be added alongside foaming agents to improve curing speed of the gel matrix during foaming. However, catalysts are not a necessary addition during either step and foaming may be conducted without the use of a catalyst. In an example, the catalyst addition rate typically is between 1.0 and 0.01% of the final composition by weight.

In an example, when combining the polycyclic carbonates with polyamines to form a urethane bond, it is helpful to consider the materials functional equivalent weight (FEW). The FEW helps to determine the appropriate weight of each monomer (polycyclic carbonate and polyamine) that should be used to achieve the desired polymerization characteristics in a NIPU foam composition. The FEW is determined by taking the individual monomer molecular weight and dividing it by the number of functional sites or the degree of functionality per molecule. The FEW then provides a weight typically in g/mol per functional group. In an example, a NIPU foam composition is produced having the starting materials provided in a ratio of cyclic carbonate functional group to amine functional group in a range of 4:1 to 1:4 including 3:1 to 1:3 as well as 2:1 to 1:2, and further 1.5:1 to 1:1.5. In yet another example, the ratio of cyclic carbonate to amine is 1:1.

A greater ratio shifted towards the cyclic carbonate or amine may be required to counteract effects of side reactions or to leave functionality available for reactions after the production of a NIPU foam. Side reactions may be purposeful, such as the route to produce amide linkages described herein or they may be unintentional and/or unavoidable such as amines reacting with CO₂ in the presence of water to form carbamates or cyclic carbonates degrading to form epoxides and releasing CO₂. The FEW allows intended cyclic carbonate to amine ratios to be achieved by multiplying the ratio for each monomer by the FEW to get the required weight for that monomer. In an example, if the FEW for the polyamine were high and the ratio required for amines is one (1) polycyclic carbonate per four (4) amines, then a high weight of amine (up to 90%) in a final composition could result even though the ratio between the monomers did not exceed 4. Likewise, in the opposite conditions, the weight percentage could be very low (as low as 5%) even though the ratio between monomers did not exceed 4.

To form a desired NIPU foam composition, through chemical foaming, a suitable foaming ingredient is required. Example foaming ingredients may include an accelerant, a surfactant, a blowing agent and/or a combination thereof. The foaming ingredients are generally used in a loading from 0.5% to 20% including 2% to 17.5% and 3% to 15%, or various combinations within these ranges. To produce the NIPU foam, the foaming ingredient includes a blowing agent having a carbonate or a bicarbonate.

The present disclosure provides for use of a carbonate or bicarbonate (collectively “carbonate”) as a primary blowing agent for NIPU foam production. Carbonate blowing reactions have several effective characteristics which make them well suited for NIPU foaming. For example, cyclic carbonates can be thermally activated and since heating the reaction mixture during foaming also helps to speed along curing reactions, temperature can be used as a way to tune and control the rate of curing reactions as well as gas generation to maintain balanced reaction rates. The inherent balance of PU foaming reactions is effective in meeting industry demands for the PU foaming markets and carbonate decomposition reactions results in a similar characteristic tunability by utilizing cure temperature. Additionally, carbonates are affordable, abundant, and safe to use. Furthermore, carbonate decomposition can be accelerated in the presence of acids and water giving further reaction tunability and reducing dependence on temperature alone. This reaction tunability changes the speed of gas evolution to better match the development rate of the NIPU crosslink network. By better matching the rate of crosslink formation to the rate of gas formation, foam formation including bubble development, dispersion, and growth can be improved and the resulting mechanical properties of the foam can be improved. When in the presence of acids and water, carbonates degrade at low enough temperatures that heating the foam mixture excessively, which increases cost and the potential unwanted side reactions that do not yield urethane linkages, becomes unnecessary. By utilizing the tunability of carbonate decomposition reactions with heat, water and/or acids, the foam development is, therefore, able to be controlled and NIPU crosslinks are able to be maintained without degrading due to overheating. This tunability of the carbonate based foaming agents, therefore, allows cyclic carbonates and amines to be reacted in the presence of the carbonate foaming agent with both crosslinking and gas formation reactions preceding in tandem during the foaming step. This allows for a single-step foaming process with no need to form NIPU in advance of foaming in order for proper foam formation and effectively addresses the slow reaction rates typical of NIPU reactions. Moreover, the present disclosure provides for a reaction product with the absence of physical blowing agents.

Examples of suitable carbonates include calcium carbonate, ammonium bicarbonate, sodium bicarbonate, potassium bicarbonate, sodium carbonate, calcite, aragonite, dolomite, kutnohorite, ankerite, magnesium carbonate, barium carbonate, potassium carbonate, zinc carbonate, copper carbonate, silver carbonate, carbonates or bicarbonates of group 1 metals, carbonates or bicarbonates of group 2 metals, carbonates of transition metals, and others. Carbonate decomposition generates CO₂ which is a suitable blowing gas for NIPU foam production and depending on the carbonate selected, may also generate meaningful quantities of water and ammonia which may act as a blowing agent depending on foaming temperature or even catalyze further urethane crosslink formation in the case of ammonia. Suitable foaming temperatures range from around 0° ° C. to 160° C., including 10° ° C. to 150° C., as well as 20° C. to 140° C.

Carbonates can be selected based on their cost, thermal decomposition temperature, gas contribution, metal salt reaction products, and/or other factors. For instance, a carbonate may be selected to produce a metal salt byproduct that produces a beneficial effect such as mold resistance. In an example, copper (II) carbonate may be used for instance so that as a byproduct of gas formation a copper metal salt can be formed such as copper sulfate. Copper sulfate is a well-known and potent anti-bacterial, anti-fungal, anti-algal and anti-microbial agent, which if properly incorporated into the NIPU foam could allow it to likewise exhibit these protective properties. In certain industries such as the bedding industry or the footwear industry producing PU foam products which are sufficiently protected from mold or fungal growth is a significant challenge. Therefore, carbonate selection could be an important route to confer an even greater benefit to a NIPU foam composition. Other metal salts are also known to contribute similar protective benefits including but not limited to silver, zinc, and barium and carbonate selection could be targeted to achieve an enhanced NIPU foam with protective qualities. Carbonate loading can range, by weight, depending on foam density targets from 0.5 to 15% loading, including 1 to 12.5% as well as 1.5 to 10% and various combinations within these ranges.

Accelerants as mentioned above include acids and water. Water acts as a solvent and allows acid/carbonate reactions to proceed and the acid is used to quicken carbonate decomposition producing a salt byproduct. Using organic acids, especially polycarboxylic acids, can allow amines to react with the carboxylic acid salts formed to generate amide linkages in the polymer matrix which may allow for improved and/or tailored material properties of a finished foam. Likewise using phosphoric acids and Lewis acids may also allow the acid to serve a dual purpose in both catalyzing curing and accelerating gas formation in the same accelerant. Accelerant loading may range from 0 to 15% loading, including 0.5 to 12.5%, and 1 to 10% and various combinations within these ranges. If using an accelerant, the amount of amine used may need to be adjusted to account for amines lost to amide linkage formation and/or carbamate formation due to reaction with CO₂ in the presence of water.

Surfactants aid in emulsifying the water, amine, cyclic carbonate mixture and reducing the surface tension of cells as they form in the foam thereby preventing cell coalescence. There are many types of surfactants commercially available which may be suitable depending on the application and the type of cyclic carbonate, and amines selected. Suitable surfactants include but are not limited to: silicone-based surfactants, stearates, polyethylene glycol, polyethylene oxide, polyorganic acids, sodium dodecyl sulfate, ethylene oxide, polypropylene oxide, alkoxylates, and propylene glycol. Surfactant loading may range by weight from 0 to 15%, including 0.5% to 12.5%, and 1 to 10%, or various combinations within these ranges.

After a mixture of polyamine, polycyclic carbonates, foaming ingredients and catalysts, if desired, is selected, foam production can be achieved following a modified PU foaming technique. In an example, the resultant reaction product is a bio-based NIPU foam composition. The polyamines and polycyclic carbonates can be mixed with or without catalysts in the absence of foaming ingredients to establish a partially cured gel matrix, which is suitable for capturing and holding air bubbles as they are formed. In an example, the time it takes to establish a partially cured gel matrix or the initial cure time is from 1 second to about 20 minutes. In another example, this may take 10 seconds to 19 minutes, 30 seconds to 18 minutes, 1 minute to 17 minutes, 2 minutes to 16 minutes, 3 minutes to 15 minutes, 4 minutes to 14 minutes, 5 minutes to 13 minutes, 6 minutes to 12 minutes, or longer depending on the catalysts (if a catalyst is used) and the reaction rates of the polyamines and polycyclic carbonates. After the gelling period the material is ready to accept foaming ingredients. Adding foaming ingredients before the polymer has sufficiently gelled may cause the evolution of gases before they are ready to be captured by the polymer allowing more gas escape and less foam expansion. If water and acid accelerants are used it may also lead to a higher rate of carbamate or amide formation with the unreacted amines depending on the acids used which may harm the material properties of a finished product.

After gelling time is complete, one or more foaming ingredients can be added and then mixed briefly before adding to an oven. At least one of the foaming ingredients added is a blowing agent having carbonate. In an example, the adding of the foaming ingredient is for up to 1 minute before adding to an oven. In an example, the mixing can be done with a high shear mixer. Oven temperature settings can be set based on the polymer cure rate and desired gas evolution rate when considering the thermal decomposition temperature of a chosen carbonate. After a sufficient cure time in the oven, a foam will be formed which can be demolded and cured, having a urethane bond between the cyclic carbonate and the amine. Additional curing to achieve full cure can take place over the next 24 to 48 hrs., during which the foams final properties will develop. The resulting NIPU foam composition is produced having densities ranging from 1 to 400 kg/m³ including 2 to 350 kg/m³, 5 to 300 kg/m³, 10 to 200 kg/m³ and 15 to 100 kg/m³. Additionally, the resulting NIPU foam is produced having a Shore A hardness in a range from 1 to 80 including 3 to 70 as well as 5 to 60, 8 to 50 and 10 to 40. The present disclosure provides for a method of producing a bio-based NIPU foam composition according to the steps set forth hereinabove.

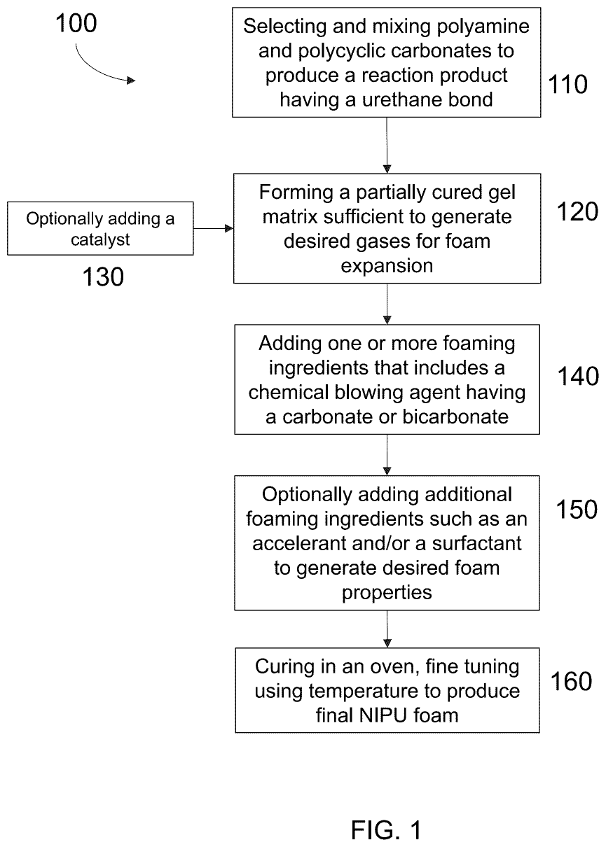

Referring to FIG. 1, an example flow chart of process 100 of making a NIPU foam according to the present disclosure is provided. In this example, the process starts at step 110 where polycyclic carbonates and polyamines are selected to form the desired foam and mixed to form a urethane bond. The starting materials can be bio-based. The mixture is allowed to react and partially cure forming a gel matrix in step 120. A catalyst can optionally be selected in step 130 and added to the mixture to assist with the partial curing and forming of the gel matrix. The gel matrix should be allowed to cure for a time sufficient to produce a desired gas content without letting the gas evolve out of the mixture to ensure an effective foam expansion. Moreover, a FEW ratio of the polycyclic carbonate and amine starting material can be tuned to ensure a desired NIPU foam reaction product. The process continues to step 140 where a foaming ingredient is added. The foaming ingredient includes a chemical blowing agent that includes at least a carbonate (e.g. a carbonate or a bicarbonate). In step 150, additional foaming ingredients such as accelerants, catalysts, and surfactants can optionally be added to generate a PU foam having certain desired properties. In this step, the reaction rate and the reaction product are tunable based on the amount of those components and the time allowed to react. The process continues to step 160 where it is cured at a desired temperature. This can be done in a suitable oven and for a suitable period of time to generate the resulting NIPU foam. The curing step allows for temperature tuning of the reaction rate and reaction product to ensure proper foam expansion and formation.

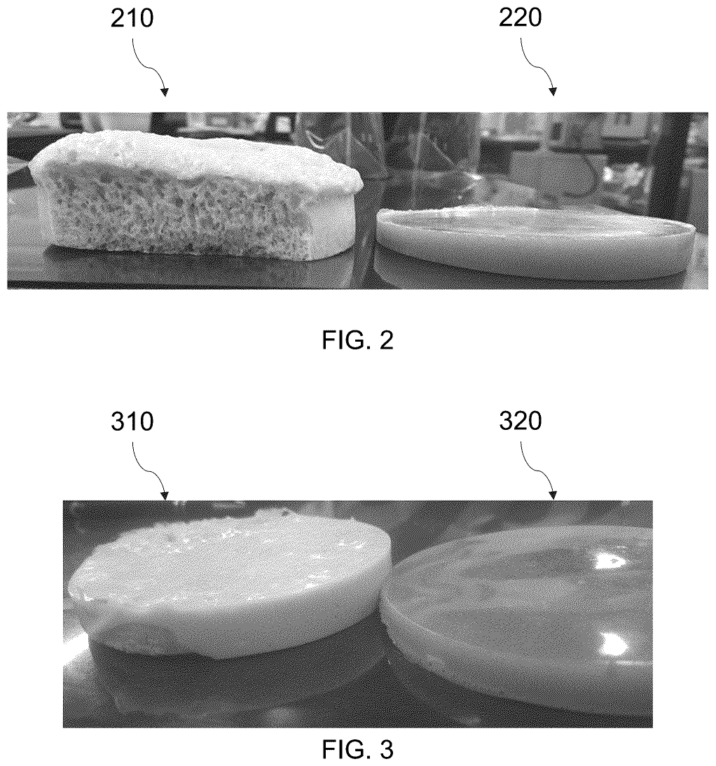

FIG. 2 is a photograph showing a side-by-side of a foamed NIPU material 210 and an unfoamed NIPU blend materials 220. In this example, the NIPU is composed of cyclic carbonate derived from triacylglycerols from linseed and hexamethylene diamine. Ammonia bicarbonate was used as the blowing agent. A silicone surfactant was used in this sample with the trade name VORASURF and no catalyst was used.

FIG. 3 is an example photograph of side-by-side of a foamed NIPU material 310 and an unfoamed NIPU blend material 320. In this example, the NIPU was formed using no catalyst or surfactant. Sodium bicarbonate was provided as the chemical blowing agent rather than ammonia bicarbonate, but had the same cyclic carbonate and amine of FIG. 2. These samples are shown without a cut into its cross-section so that the interior foam structure is not visible. These photographs illustrate a clear difference in size, density and hardness when a foam is compared to an unfoamed counterpart.

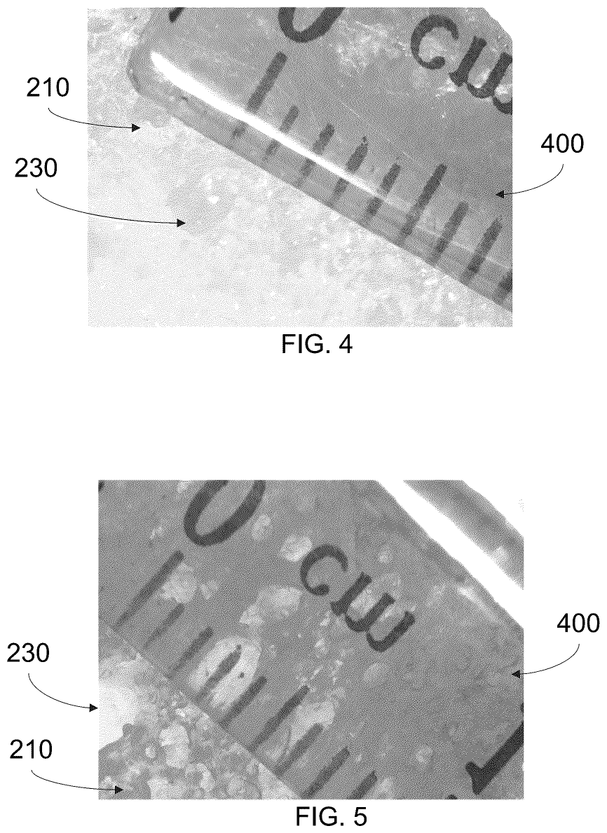

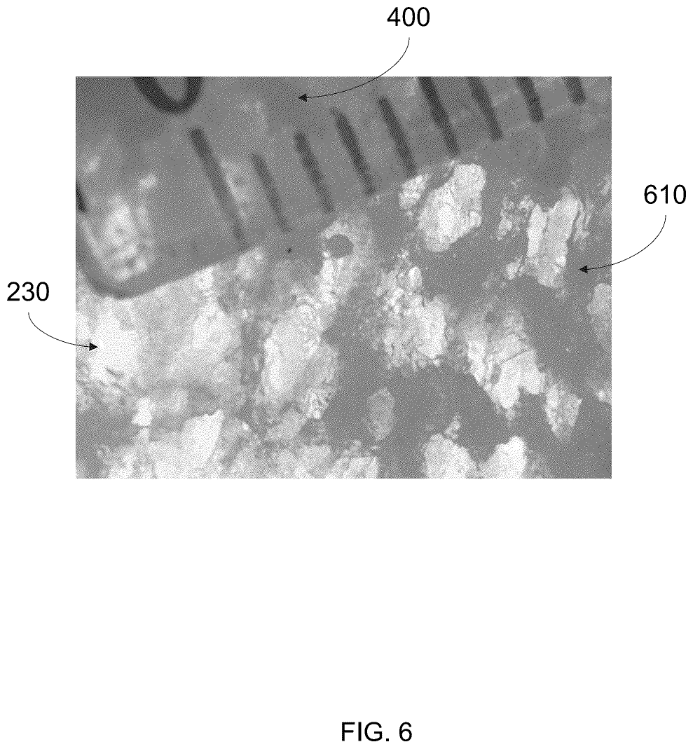

FIGS. 4 and 5 are microscope photos taken at 10× zoom of a NIPU foam 210 of FIG. 2. FIG. 6 is a microscope photo taken at 10× zoom of a NIPU foam 610 with no surfactant and with triazobicyclodecene as a catalyst. These images show a ruler 400 with millimeter markings illustrating the void/space formation 230 within the foamed material.

### EXAMPLES

Carbonated Linseed Oil (CLO) was obtained and had an average molecular weight of 1128 g/mol and a functional equivalent weight (FEW) of 222.3 g/mol. Hexamethylene diamine (HMDA) was obtained from SIGMA ALDRICH with a molecular weight of 116.21 g/mol and a FEW of 58.1 g/mol. Foaming agents included citric acid powder and ammonium bicarbonate. A reaction catalyst triazabicyclodecene (TBD) was obtained from AK SCIENTIFIC. A cell stabilizer Vorasurf DC 5951 was obtained from DOW CHEMICAL.

Two experiments were performed. One included the silicone surfactant Vorasurf DC 5951 and one did not. Material was prepared according to a 100 g polyurethane batch size. See Table 1 for batch formula:

TABLE 1
NIPU formulation

| Ingredient | Grams (g) |
|---|---|
| Carbonated linseed oil (CLO) | 79.3 |
| Hexamethylene diamine (HMDA) | 20.7 |
| Citric Acid | 2.67 |
| Ammonium Bicarbonate | 5.78 |
| Triazabicyclodecene (TBD) | 0.3 |
| DI Water | 3.34 |
| Vorasurf 5951* | 0.5 |

CLO and HMDA were pre-heated to 60° ° C. in a convection oven in preparation for foaming reaction. Next, the dry ingredients including 2.67 g of citric acid, 3.3 g of ammonium bicarbonate, and 0.3 g of TBD were weighed into separate weigh boats. Weighing out dry ingredients was done just before conducting the reaction to prevent excessive moisture uptake from the environment in the citric acid. Additionally, before retrieving the pre-heated CLO and HMDA, 3.34 ml of DI water was measured out into a graduated cylinder. Next, 79.3 g of CLO were poured into a 400 ml beaker while still warm. The small amount 0.3 g of TBD catalyst was added to the CLO and mixed vigorously for a few seconds using a high shear mixing implement attached to a drill. Next 20.7 g of HMDA was weight out into a separate glass beaker while melted and quickly added to the CLO beaker to prevent the HMDA from crystallizing on the glassware before it is poured. The high shear mixture was used to stir the HMDA into the CLO vigorously for about 2 minutes moving the mixer up and down in the mixture and scrapping the beaker walls to ensure a good mix. Then, the remaining dry ingredients were added slowly with the citric acid being added before the ammonium bicarbonate. If the Vorasurf DC 5951 was included, it was added immediately following the dry ingredients by pipette.

Once the mixture was evenly mixed (between about 30 seconds to 1 minute), the DI water was added to the mixture and stirred in for a few more seconds (e.g., less than about 10 seconds). After mixing in the water, the mixture immediately began to produce air bubbles as the acid and carbonate reacted. The mixture was then poured swiftly into a silicon mold and then immediately placed into a convection oven pre-heated to 80° C. The mixture was left to cure for at least 15 minutes before it was removed from heat and cooled. After cooling to room temperature or near room temperature the NIPU foam was removed from the silicon mold. The samples were initially very soft and springy to the touch with a very slow rebound characteristic. However, after 24 hours, the foam became much stiffer and after several weeks developed into a very stiff polymer with a significant resistance to compression or deformation. In the optimal expression of this formula, the TAG-rich CLO would be replaced with a carbonated FAME mixture with the average fatty acid degree of unsaturation being slightly over 2. This could make the formula easier to mix and more likely to produce small, well distributed, and consistent cells in the foam and would likely result in a more flexible foam.

Additionally, an experiment was conducted using deacetylated chitin as the amine source in the hydroxy polyurethane bond. The same CLO from the experiment above was used, but the partially deacetylated (75%) chitin was sourced from SIGMA ALDRICH. The experiment was conducted with a 20 g batch size targeted. See table 2 for batch formula:

TABLE 2

| | |
|---|---|
| 75% Deacetylated Chitin | 10 g |
| Carbonated linseed oil (CLO) | 10 g |
| 95% Ethanol | 50 ml |
| 5% Acetic Acid solution | 5 ml |
| DI Water | 100 ml |
| Sodium Bicarbonate | 1.156 g |

Because the CLO was still in the form of a triacylglycerol rich oil, it was too viscous to be mixed with chitin directly. Accordingly, the CLO was dissolved in 50 ml of ethanol at 80° C. Then the CLO solution was left to cool. Next, chitin was mixed with water and acetic acid to make chemically available (decrystallized) chitin polymers and amine groups. It was mixed until a creamy gel was formed from the chitin powder. Then the CLO-ethanol mix was added to the chitin gel and was mixed with a high shear mixer for about 2 minutes. After the mixture was well mixed, it was poured into a mold and the sodium bicarbonate was added. The sodium bicarbonate should be mixed-in while adding and should only be mixed for a few seconds. With the addition of the sodium bicarbonate, the mixture quickly turned into a hydrogel. The hydrogel was added to an oven at 80° C. for 24 hours to cure. After 24 hrs the hydrogel was desiccated and polyurethane had cured leaving behind a foam.

The reaction tunability described in this disclosure which impacts reaction rate and the resulting reaction product is accomplished in some cases by using accelerants such as water and/or acids to control gas formation as described previously. The addition of these accelerants not only contributes to the intended reaction rate tunability but also may contribute to side reactions some with benefits and some less beneficial. What follows is a disclosure of side reactions and their benefits or consequences if any exist.

Water contributes to side reactions. Water is necessary for carbamate formation from amines and CO₂. The formation of carbamates may be used to slow gas formation by removing available CO₂ thereby delaying or slowing bubble growth to prevent early bubble collapse or the outpacing of NIPU crosslink formation. The carbamate formation may also negatively impact foaming by driving a greater need for blowing agent to account for gas loss or it may also scavenge amine content leading to a lack of full conversion of cyclic carbonates to NIPU.

Water also is necessary for the hydrolysis of cyclic carbonates previously disclosed which degrades cyclic carbonates to hydroxyls and releases CO₂. This can be used to supplement or replace carbonate-based chemical blowing agents by treating cyclic carbonate like a chemical blowing agent itself. However, it would also leave behind hydroxyls which would not react with amines readily reducing the overall crosslink density and if not controlled or planned for leaving unreacted amines. This would inherently weaken the material and leave it more flexible overall or may even prevent foam or polymer formation if cyclic carbonate is not used in excess to account for waters impact on cyclic carbonate functionality. Though amines and hydroxyls are not reactive on their own, bridging agents may also be used such as anhydride rings like succinic anhydride, maleic anhydride, phthalic anhydride, glutaric anhydride, cis-5-norbornene-endo-2,3-dicarboxylic anhydride (NA), tetrahydro phthalic anhydride (THPA), 1,2-napthalic anhydrides (1,2-NA), 3,4-dimethyl phthalic anhydride (3,4-DMPA), diphenic anhydride (DPA), tricyclic anhydride (TCA) as well as others and any combination thereof. These bridging agents may be added before foaming commences, after the gel stage is reached, or even at later stages of foam development to increase crosslink density as needed and bridge amine to hydroxyl networks. However, it should be noted that the earlier in the process the anhydride additions occur the more likely they will compete with cyclic carbonates for available amines. If water driven hydrolysis of cyclic carbonates is not desired, then pH can be kept in more acidic conditions as the hydrolysis of cyclic carbonates favors alkaline conditions.

High heat is also a driver for side reactions with cyclic carbonate. In high heat conditions cyclic carbonate can decompose releasing CO₂ and generating an epoxide. The excessive generation of epoxides can pose problems due to amines reacting faster with epoxide rather than cyclic carbonates which would create a dominance of epoxy linkages over the desired NIPU linkages. The shift to epoxy dominated linkages would shift foam to harder/stiffer properties overall lowering the range of useful market applications. However, a shift to more epoxy dominated compositions would likely also contribute to faster gel formation making foam formation faster. A more epoxy dominated foam formation would also likely yield increased thermal stability of the foam product as well as increased strength and other properties. The side reaction yielding the decomposition of cyclic carbonates to epoxies would however differ from the addition of epoxies in that the epoxies would not be multifunctional epoxies. However, an epoxy added by design would necessarily be multifunctional so that it does not terminate polymerization. This would mean that while stiffening would occur it would not be nearly as prevalent as would be generated by the multifunctional epoxy since much of the original cyclic carbonate functionality would be maintained. However, high heat can also reverse urethane bond formation from cyclic carbonate and amines making high heat side reactions some of the least desirable which further emphasizes the importance of tuning reactions with acid and water to avoid high heat.

As previously disclosed, acids used may be organic acids especially multi-functional carboxylic acids which can be crosslinked with amines to form amide linkages. Amide linkages can be used to tailor the resulting foam properties to contribute additional strength and resilience as well as thermal stability. However, amide linkages would also lead to greater stiffness/hardness and would also shift glass transition temperature to higher temps increasing the potential for brittle failure of polymers in use. Carboxylic acids reacting with metal carbonates general donate protons generating carboxylates which are fairly unreactive to amines, but reaction can still be catalyzed with an appropriate acceptor of the charged oxygen such as dicyclohexylcarbodiimide (DCC) to allow for reactions with amine if amide formation is desired.

Understanding these side reactions can be useful in generating effective use of reaction tunability. While acids, water, and/or heat are used to tune carbonate decomposition, side reactions should also be managed to ensure a reaction product with the properties desired. The control of acid type, water concentration and the use of heat are all levers that can be utilized and configured to tune the reaction, effectively managing reaction rate and reaction products produced.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

What is claimed is:

1. A thermoset non-isocyanate polyurethane (NIPU) foam composition comprising:
a reaction product of:
(a) a polycyclic carbonate, having a plurality of cyclic carbonate functional groups, ranging from 5 to 90% of NIPU foam composition ingredients by weight;
(b) a polyamine, having a plurality of amine functional groups, ranging from 5% to 90% of the NIPU foam composition ingredients by weight; and
(c) a foaming ingredient configured to produce the NIPU foam composition ranging from 0.5 to 20% of the NIPU foam composition ingredients by weight, wherein the foaming ingredient comprises a carbonate-based chemical blowing agent;
(d) an optional accelerant introduced with the chemical blowing agent, wherein the accelerant includes acid and/or water;
wherein the polycyclic carbonate and the polyamine form a urethane bond, and wherein one or more characteristics of the NIPU foam composition are tunable by changing cure temperature, acid composition, and/or water content.

2. The NIPU foam composition of claim 1, wherein the cyclic carbonate functional groups and the plurality of amine functional groups are provided in a functional equivalent weight (FEW) ratio in a range from 4:1 to 1:4.

3. The NIPU foam composition of claim 1, wherein the plurality of cyclic carbonate functional groups and the plurality of amine functional groups are provided in a functional equivalent weight (FEW) ratio in a range from 2:1 to 1:2.

4. The NIPU foam composition of claim 1, wherein the polycyclic carbonate is bio-derived and includes a carbonated triacylglycerol (TAG) or a fatty acid methyl ester (FAME) derived from one or more natural oils.

5. The NIPU foam composition of claim 1, wherein the polycyclic carbonate comprises 15 to 80% of the NIPU foam composition by weight.

6. The NIPU foam composition of claim 1, wherein the polyamine is a bio-derived compound selected from the group consisting of hexamethylene diamine (HMDA), putrescine, cadaverine, chitosan/chitin, pentamethylene diamine (PMDA), decarboxylated lysine and polylysine.

7. The NIPU foam composition of claim 1, wherein the polyamine comprises 15 to 80% of the NIPU foam composition by weight.

8. The NIPU foam composition of claim 1, wherein the resulting NIPU foam material defines a density from 1 to 400 kg/m³.

9. The NIPU foam composition of claim 1, wherein the resulting NIPU foam material defines a Shore A hardness from 1 to 80.

10. The NIPU foam composition of claim 1, wherein the reaction further includes a catalyst introduced into the reaction prior to the combination with the carbonate-based chemical blowing agent and the catalyst is selected from the group consisting of Lewis acids and bases, phosphoric acids, carbines, phosphines, enzymes, guanidines, thioureas, triazabicyclodecene (TBD), phenylcyclohexylthiourea, and combinations thereof.

11. The NIPU foam composition of claim 1, wherein the carbonate-based chemical blowing agent is provided in a loading by weight from 0.5% to 20%.

12. The NIPU foam composition of claim 1, wherein the carbonate-based chemical blowing agent includes a carbonate selected from the group consisting of calcium carbonate, ammonium bicarbonate, sodium bicarbonate, potassium bicarbonate, sodium carbonate, calcite, aragonite, dolomite, kutnohorite, ankerite, magnesium carbonate, barium carbonate, potassium carbonate, zinc carbonate, copper carbonate, silver carbonate, carbonates or bicarbonates of group 1 metals, carbonates or bicarbonates of group 2 metals, carbonates of transition metals, and combinations thereof.

13. The NIPU foam composition of claim 12 wherein the carbonate based chemical blowing agent is selected to produce a byproduct salt configured to confer a desired protective benefit to the NIPU foam composition and the byproduct salt is a salt of a metal selected from the group of metals consisting of copper, zinc, barium, and silver.

14. The NIPU foam composition of claim 1, wherein the carbonated-based chemical blowing agent is provided with a thermal decomposition temperature of 0 to 160° C.

15. The NIPU foam composition of claim 14, wherein the reaction product includes reacting an accelerant provided at a loading range by weight up to 15%.

16. The NIPU foam composition of claim 1, wherein the reaction product further includes reacting a surfactant introduced with the chemical blowing agent, wherein the surfactant is a member selected from the group consisting of a silicone-based surfactant, a stearate, polyethylene glycol, polyethylene oxide, a polyorganic acid, sodium dodecyl sulfate, ethylene oxide, polypropylene oxide, an alkoxylate, propylene glycol, and combinations thereof.

17. The NIPU foam composition of claim 16, wherein the surfactant is provided at a loading range by weight from 0 to 15%.

18. The composition of claim 1, wherein the reaction product further includes reacting water provided to drive gas formation from cyclic carbonates to contribute to blowing gas requirements of the resulting NIPU foam composition.

19. The composition of claim 1, wherein the reaction product further includes reacting a multifunctional carboxylic acid provided to drive amide bond formation with amines to adjust one or more mechanical properties of the resulting NIPU foam composition.

20. A thermoset non-isocyanate polyurethane (NIPU) foam composition comprising a reaction product of:
(a) a bio-derived polycyclic carbonate having a plurality of cyclic carbonate functional groups, a bio-derived polyamine having a plurality of amine functional groups, and a foaming ingredient configured to produce the NIPU foam composition, wherein the foaming ingredient comprises a carbonate-based chemical foaming blowing agent, and wherein the polycyclic carbonate and the polyamine form a urethane bond;
(b) a catalyst reacted with the polycyclic carbonate and the polyamine prior to combining with the foaming ingredient;
(c) an accelerant and a surfactant provided as additional foaming ingredients configured to generate the NIPU foam composition having desired properties,
wherein the accelerant includes acid and/or water,
wherein the plurality of cyclic carbonate functional groups and the plurality of amine functional groups are provided in a ratio in a range from 4:1 to 1:4,
wherein the bio-derived polycyclic carbonate and the bio-derived polyamine form a urethane bond, and
wherein characteristics of the NIPU foam composition are tunable by changing cure temperature, acid composition, and/or water content.
